(19) United States
(12) Patent Application Publication
(10) Pub. No.: US 2003/0035933 A1
(43) Pub. Date: Feb. 20, 2003

(54) Heat applied graphics and method

(76) Inventor: Brett A. Stahl, Grosse Pointe Farms, MI (US)

Correspondence Address: Ralph M. Burton, Brooks & Kushman P.C., 22nd Floor, 1000 Town Center, Southfield, MI, 48075-1351, US

(21) Appl. No.: 09/931,569

(22) Filed: Aug. 16, 2001

(51) Int. Cl. B32B 3/00

(52) U.S. Cl. 428/195

(57) ABSTRACT

Graphics for heat sealing attachment to fabrics and hard surfaces are made by flooding a release paper with screenprinting ink and then covering the ink with a thermally responsive adhesive after which the ink and adhesive are kiss-cut in reverse to the release paper preferably by a laser cutter whose power is set to singe the cut at the adhesive to highlight the indicia and facilitate weeding; the ink flooding may be arranged in multiple congruent patches spaced from the edges of the release paper so that upon cutting the paper into sub-sheets, uniform margins are provided about each patch, and the indicia may be accurately positioned in each patch.

### BACKGROUND OF THE INVENTION

1. Field of the Invention

This invention relates to graphics which are heat-sealed to fabrics and hard surfaces, and to methods of making such graphics.

2. Background

While heat-applied graphics for fabrics and hard surfaces have been available for many years, there has been a continuing need to reduce the cost thereof and to speed the imprinting operations. The release sheet upon which the indicia are carried for positioning and applying the indicia to fabrics and hard surfaces has in some instances been as costly as the indicia themselves. This is because the release sheet has been made of Mylar® or other smooth plastic sheet material whose cost is high and which is durable only in rolled form. Mylar® is used because it is transparent and allows visual positioning of the graphics on the article being decorated.

In addition, where the indicia consist of, for example, letters and numbers arranged in a predetermined pattern, it was a time-consuming operation for the imprinter to position the letters and numerals on the garment to be decorated before heat-sealing the letters and numbers thereto.

### SUMMARY OF THE INVENTION

I have discovered that utilizing the novel method of making the graphics disclosed herein, they may be formed of multiple letters and/or numerals accurately positioned on paper or Mylar® release sheets such that by positioning the release sheet itself, the imprinter will be able to transfer the indicia to the surface to be decorated with the indicia appearing in exactly the location desired. In addition, my method allows the indicia comprising the graphic to be accurately located with respect to each other and with respect to the margins of the release sheet.

In carrying out my method, a paper or Mylar® release sheet having a release coating on one surface is flooded with a heat transfer ink to form an ink patch accurately positioned with respect to the margin of the release sheet. The flooding of the sheet may be accomplished by utilizing conventional screenprinting techniques. A plurality of such patches may be formed on each release sheet with the patches being spaced from each other and from the marginal edges of the sheet so that upon subsequently cutting through the release sheet identical sub-sheets may be produced.

Heat-sealable adhesive is then applied to the exposed surface of the ink patch or patches on the release sheet while the ink is still in the liquid stage. Such adhesive will serve to adhere the graphic to be formed to the fabric or hard surface to be decorated.

The indicia forming the graphic design is then reversely kiss-cut through the adhesive and ink layers to the release coated surface of the release sheet. Preferably, this kiss-cutting is accomplished using a laser whose power input is adjusted to slightly singe the cut thereby outlining the graphic design and facilitating weeding of unwanted ink layer from around the graphic.

In a preferred form of the invention, a paper or Mylar® release sheet has a plurality of discrete ink patches deposited thereon in precisely controlled relation to each other and to the margin of the release sheet. An adhesive layer is deposited on the exposed surface of the patches before the ink solidifies, and the indicia is then kiss-cut in reverse from each patch. The release sheet is then cut into congruent sub-sheets. Either before or after this cutting unwanted portions of the ink layer may be weeded away from the graphic design. As a result, the cost of producing heat-sealable graphics can be substantially reduced while graphics equal or better than that heretofore realized may be enjoyed.

### BRIEF DESCRIPTION OF THE DRAWINGS

FIG. 1 is a plan view of a release sheet having graphics kiss cut in reverse thereon in accordance with my invention;

FIG. 2 is a schematic rendition of the method by which the graphics are made;

FIG. 3 is a cross-sectional view taken on the line 3-3 of FIG. 2 but with the conveyor belt omitted;

FIG. 4 is a cross-sectional view taken on the line 4-4 of FIG. 2 but with the conveyor belt omitted;

FIG. 5 is a cross-sectional view through a laser kiss-cutting of the ink and adhesive layers; and

FIG. 6 is a cross-sectional view through ink and adhesive layers as unwanted material is being removed.

### DETAILED DESCRIPTION OF THE PREFERRED EMBODIMENTS

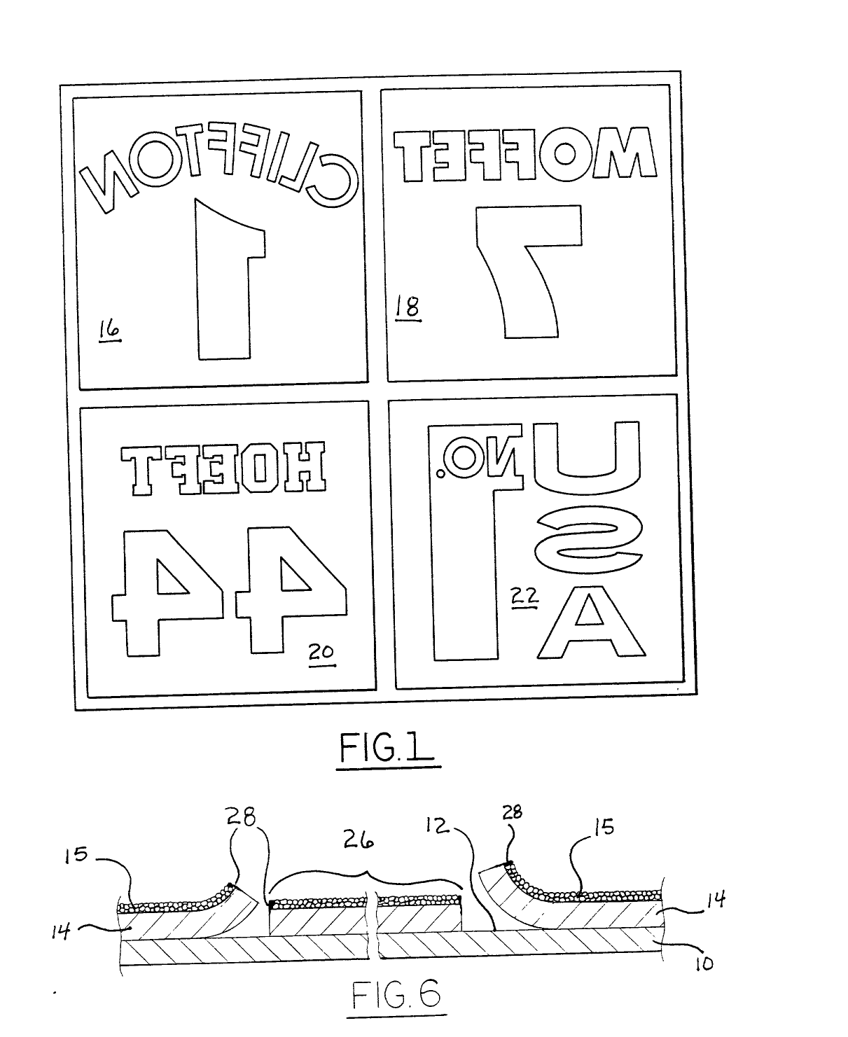

Referring to FIGS. 1 and 6, a paper or Mylar® release sheet 10 is coated on one surface 12 with a release agent. Release paper suitable for this method is sold under the name Trans-French T75/Transfer T75. This is a well-known release/transfer paper manufactured in France but available from many screenprinting equipment or ink suppliers including Union Ink Company of 453 Broad Avenue, Ridgefield, N.J. 07657. Other release papers may also be available for utilization in practicing this method.

The release surface 12 of the release sheet 10 is flooded by a water or solvent-based heat transfer type ink 14. An ink suitable for this purpose is a high opacity screenprinting ink manufactured by Union Ink. This ink is a plastisol commonly used in screenprinting.

In a preferred embodiment, the ink is screenprinted onto the surface 12 of the release paper or sheet in a plurality of congruent patches, four being shown in FIG. 1 at 16, 18, 20 and 22. A greater or lesser number of patches may be formed on the release sheet. The ink may be of various colors as required by the imprinter. The patches are preferably spaced apart a distance of one inch, and spaced one-half inch from the edges of the release sheet and arranged such that when the release sheet 10 is cut apart between the patches, the margins of the sub-sheets will be uniformly one-half inch around each patch.

Following flooding of the release surface of the release sheet 10, and before the ink solidifies, the exposed surface of the ink layer 14 is coated with a heat sensitive adhesive such as a granular type formulated using PVC or other suitable heat-responsive adhesive 15. The adhesive may be varied in accordance with the type of surface to which the graphics are to be applied. For example, the polyvinyl chloride adhesive is suitable for use with cottons and polyesters, while a different type of adhesive would perhaps be more suitable for other fabrics or surfaces, for example, such as nylons. Suitable adhesives for this purpose may be obtained from Bostick, 211 Boston Street, Middleton, Mass. 01949. It is identified as a co-polyester powder adhesive. Several such adhesives are available on the market and would be suitable for this process.

Following the application of the adhesive 15, and solidification thereof, the indicia are kiss-cut in reverse through the adhesive and ink layers to the release surface 12 of the release paper 10 as best shown in FIGS. 5 and 6. This kiss-cutting is preferably done utilizing a laser cutter. The power to the laser cutter is adjusted to slightly singe the edges of the cut ink layers adjacent the adhesive layer. In the preferred embodiment, it is understood that no singeing appears on the edge of the ink layers adjacent the release paper 10. The singeing discolors the ink layer slightly only adjacent the adhesive layer thereby facilitating weeding of unwanted material from around and within the indicia. It is to be noted that, if, for example, a knife is used to cut the indicia in the ink layer, the benefit of the singeing will not be obtained. This singeing does not appear in the final product as applied to the fabric or hard surface because the singed edge is against such surface. The laser cutter is schematically shown at 24 while the laser itself is depicted schematically at 26 in FIG. 5.

The kiss-cutting of the indicia in the patches 16, 18, 20 and 22 may be accomplished by the laser or the knife on a cutting table under the control of a computer (not shown). The layout and spacing of the indicia may be accurately programmed into the computer to provide for the location of the indicia with respect to the edges of the patches, the spacing of the letters, numerals or designs with respect to each other within each of the graphics and with this programmed into the computer, the kiss-cutting may be carried out to produce an accurately positioned and pre-spaced indicia to provide the final graphics product.

Following kiss-cutting of the patches, the cutter may be utilized to cut the release paper 10 into individual sub-sheets, each containing the desired indicia. Either before or after such cutting, the weeding away of unwanted material may be effected as schematically shown in FIG. 6 where the central portion 26 is to remain on the transfer sheet while portions to the right and left thereof, as shown in FIG. 6, are peeled away during the weeding. The singed edges of the indicia are schematically indicated at 28 in FIG. 6.

Because the patches 16, 18, 20 and 22 have been accurately positioned to provide uniform margins of release sheet around each patch after the release paper is cut up, and because the graphics are accurately positioned on each patch, and the indicia are accurately positioned and spaced apart in each patch, the imprinter need only position the release sheet uniformly on each garment or the like to be decorated, and then the heat sealing operation performed, and thereafter the release sheet peeled away, to result in the graphics being accurately transferred and positioned on the surface being imprinted.

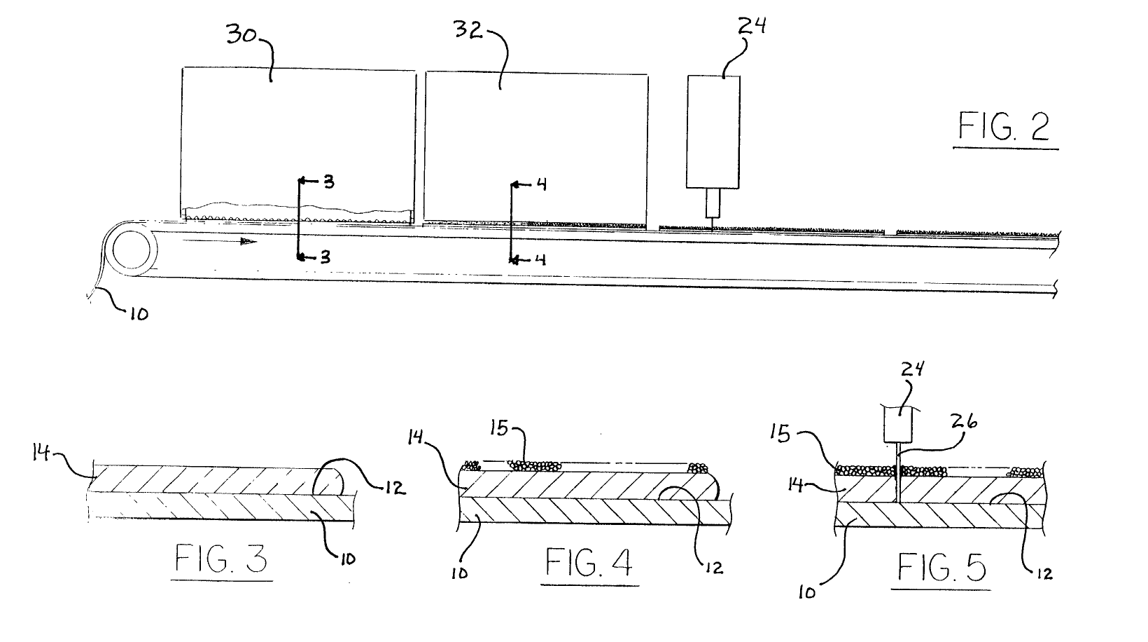

The entire production of the graphics may be carried out in a production environment using a conveyor system schematically shown in FIG. 2, or transfer frames within which the transfer sheet may be mounted prior to the screenprinting thereof and application of the adhesive. The conveyor or transfer frames can be utilized to move the product during its manufacture from a screenprinting station shown schematically at 30 where the ink is applied to the transfer sheet 10 and the conveyor can then move the paper to the adhesive sprinkling or coating station 32 and finally the paper is moved beneath the cutter 24 where the kiss-cutting of the indicia is carried out. Between stations 32 and the kiss-cutting operation, the ink layer will be solidified.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. The method of making graphics for heat sealing application to fabrics and hard surfaces comprising:
flooding the release surface of a release sheet with a heat transfer ink in a liquid stage;
while the exposed surface of the ink is still in the liquid stage applying thereto a thermoplastic adhesive;
causing the ink with the adhesive thereon to assume a solid stage; and
thereafter kiss-cutting through the adhesive and ink to said release surface of the release sheet to form the graphic.

2. The method of claim 1 wherein the ink is a screenprinting ink.

3. The method of claim 1 wherein the ink is applied as discrete congruent patches.

4. The method of claim 1 wherein the flooding of the release surface by ink is by screenprinting the ink thereon.

5. The method of claim 1 wherein the ink is a water or solvent based heat transferrable plastisol.

6. The method of claim 1 wherein the kiss cutting is by laser cutting wherein the power supplied to the cutter is sufficient to singe the ink along the cut line only adjacent the adhesive to render the line readily visible for weeding.

7. The method of claim 1 wherein the release sheet is made of paper with a release coating on one surface thereof.

8. The method of claim 1 wherein the release sheet is paper with a release coating on one side thereof.

9. The method of claim 8 wherein the kiss-cutting is performed by laser cutting with the power to the laser adjusted to singe the cut.

10. The method of claim 8 wherein the kiss-cutting is performed successively on the patches on each release sheet.

11. The method of claim 8 wherein the flooding of the release sheet with ink is by screenprinting successive areas of the sheet to provide discrete patches of ink.

12. The method of claim 8 wherein the flooding of the release sheet with ink is by simultaneously screenprinting all of the discrete ink patches on the release sheet.

13. The method of making a readily weedable heat applied graphic comprising:
providing a release sheet coated on one surface with an ink layer; and
kiss-cutting through the ink layer to the coated surface of the release sheet with a laser cutter and adjusting the power to singe the cut edges of the ink whereby they are readily visible for weeding.

14. The method of making perfectly aligned and pre-spaced heat transfer indicia on release sheets for application to fabrics or hard surfaces comprising:
flooding the release surface of a release sheet with a plurality of discrete congruent patches of heat transfer ink in the liquid stage, such patches being so arranged on the sheet and separated from each other that the sheet may be subsequently cut apart into congruent sub-sheets with the patches congruently arranged thereon;
while in the liquid stage applying to the exposed surface of the ink a thermoplastic adhesive;
solidifying the ink;
kiss-cutting through the ink to the release sheet in each patch to provide indicia arranged in the patches;
cutting through the release sheet to provide a plurality of congruent sub-sheets having heat transfer indicia thereon; and
weeding unwanted material from each patch.

15. The method of claim 8 wherein the cutting through the release sheet is so arranged with respect to the patches that the distances between the margins of the sub-sheets and the patches is equal.

16. The method of claim 8 wherein the indicia kiss-cut in each patch comprises a plurality of letters and/or numbers spaced in predetermined relation to each other.

17. The method of decorating fabrics or hard surfaces with a plurality of indicia accurately spaced apart and accurately positioned thereon comprising:
screenprinting the release surface of a paper release sheet with a plurality of discrete congruent patches of heat transfer ink, the patches being so arranged on the sheet and separated from each other that the sheet may be subsequently cut apart into congruent sub-sheets with the patches congruently arranged thereon;
while in the liquid stage applying to the exposed surfaces of the ink patches a thermoplastic adhesive;
solidifying the ink;
kiss-cutting with a laser through the ink to the release sheet in each patch to provide identical indicia congruently arranged in the patches;
cutting through the release sheet to provide a plurality of congruent sub-sheets having heat transfer indicia thereon;
weeding unwanted ink from each of the sub-sheets; and
positioning each sub-sheet on the fabric or hard surface with the adhesive there against and heat sealing the indicia thereto.

18. Graphics for heat seal application to fabrics or hard surfaces comprising:
a paper release sheet having a release coating on one surface thereof;
an ink layer on the release coated side of the release sheet spaced uniformly from the marginal edges of the sheet;
a heat responsive adhesive coating on the exposed surface of the ink layer for adhering the layer to a fabric or hard surface; and
indicia kiss-cut in the adhesive and ink layer down to the release coating with the cut outlined by a singeing of the exposed surface of the ink layer.

19. The graphics of claim 18 wherein the ink layer comprises a plurality of identical discrete ink patches on the release sheet uniformly spaced from the marginal edges of the release sheet and the indicia is uniformly positioned on the patches in determined spaced relation from the edges of the patches.
